(19) United States
(12) Patent Application Publication
(10) Pub. No.: US 2003/0189420 A1
(43) Pub. Date: Oct. 9, 2003

(54) Method for assisting in planning of power supply schedule

(76) Inventors: Hiroyuki Hashimoto, Tokyo (JP); Yoshio Izui, Tokyo (JP); Masashi Kitayama, Tokyo (JP)

Correspondence Address: LEYDIG VOIT & MAYER, LTD, 700 THIRTEENTH ST. NW, SUITE 300, WASHINGTON, DC, 20005-3960, US

(21) Appl. No.: 10/297,327

(22) PCT Filed: Sep. 28, 2001
(86) PCT No.: PCT/JP01/08557

(51) Int. Cl. G06F 17/60

(52) U.S. Cl. 323/212

(57) ABSTRACT

There has been a problem in that when an electric power supplier carries out demand control by discount or the like, it cannot suitably estimate an amount of demand control and a cost for it. Therefore, an object of the invention is to provide a power supply plan making support method such as enables support upon making a generator operation plan and a power purchase plan by considering power demand control. A predicted cost for demand control is expressed by an equation to enable a concept of demand control to be easily reflected in equations for calculation for presenting information for an electric power supply plan, thereby enabling presentation of a suitable amount of demand control and a necessary cost.

### TECHNICAL FIELD

This invention relates to a power supply plan making support method used by an electric power supplier, e.g., an enterprise such as an electric power company having a plurality of power generation facilities, or an electric power broker to make a generator operation plan or a power purchase plan by considering power demand control.

### BACKGROUND ART

Conventional generator operation plans are such that operating/stopped states of generators according to electric power demand are determined on the basis of predicted demand values at certain points in time in a scheduled period. For example, JP 2000-300000 A discloses such a generator start/stop plan method.

According to such a generator start/stop plan method, an optimal plan is made by considering costs specific to generators (fuel cost, startup cost, etc.). However, for example, no consideration is given to the effect of reducing the generator costs by carrying out such control that the demand is reduced by discount or like means when the demand peaks. Therefore there has been a problem that when an electric power company carries out demand control by discount or like means, it cannot estimate a suitable amount of demand control and the cost of it. There has also been a problem that when an electric power broker makes a power purchase plan, it cannot estimate a suitable amount of demand control and the cost of it.

The present invention has been achieved to solve the above-described problems, and therefore an object of the present invention is to provide a power supply plan making support method enabling support to a power supplier in making a generator operation plan or a power purchase plan by considering power demand control.

### DISCLOSURE OF THE INVENTION

A power supply plan making support method according to the present invention is characterized in that an equation for predicting a cost for demand control is obtained from actual-record data on amounts of power demand control and control costs, and computation for presenting information for an electric power supply plan is performed by using the equation.

According to this method, a predicted cost for demand control is expressed by an equation to enable the concept of demand control to be easily reflected in equations for calculation for presenting information for an electric power supply plan, thereby enabling presentation of a suitable amount of demand control and a necessary cost. Thus, this method has the advantage of enabling support to an electric power supplier in making a power supply plan by considering power demand control.

Also, the method comprises a step of extracting and setting a future power demand related to a supply plan period from power demand predicted value data, a step of obtaining the equation for predicting a cost for demand control from actual-record data on amounts of power demand control and control costs, a step of making a generator operation plan draft and a demand control draft by using data on generators and a power demand prediction and the equation for predicting a cost for demand control, obtained in the steps, and a step of displaying the generator operation plan draft and the demand control draft obtained.

According to this method, a generator operation plan draft made by considering power demand control can be presented and an electric power supplier can make an actual generator operation plan by considering suitable amounts of power demand control and control costs, presented in a demand control draft.

Also, the method comprises a step of extracting and setting a future power demand related to a supply plan period from power demand predicted value data, a step of making a temporary generator operation plan draft from a power demand prediction obtained in the step and data on generators, and detecting at least one of the generators higher in operating cost and an amount of power generated by the generator, a step of obtaining of the equation for predicting a cost for demand control from actual-record data on amounts of power demand control and control costs, and obtaining by simulation a cost required for demand control of the amount of power generated by the detected generator higher in operating cost, and a step of displaying the temporary generator operation plan draft, the generator higher in operating cost, and the cost required for demand control of the amount of power generated by the generator.

According to this method, a temporary generator operation plan draft, generators higher in operating cost, and the cost required for demand control of the amount of power generated by the generators can be presented, and an electric power supplier can make an actual generator operation plan by considering these contents presented.

Also, the method comprise a step of extracting and setting a future power demand related to a supply plan period from power demand predicted value data, a step of obtaining the equation for predicting a cost for demand control from actual-record data on amounts of power demand control and control costs, a step of making a generator operation plan draft, a power purchase plan draft and a demand control draft by using data on generators, data on purchase of power, and a power demand prediction and the equation for predicting a cost for demand control, obtained in the steps, and a step of displaying the generator operation plan draft, the power purchase plan draft and the demand control draft obtained.

According to this method, a generator operation plan draft and a power purchase plan draft made by considering power demand control can be presented, and an electric power supplier can make an actual generator operation plan and an actual power purchase plan by considering suitable amounts of power demand control and control costs, presented in the demand control draft.

Also, the method comprises a step of extracting and setting a future power demand related to a supply plan period from power demand predicted value data, a step of making a temporary generator operation plan draft and a temporary power purchase plan draft from a power demand prediction obtained in the step, data on generators and data on purchase of power, and detecting at least one of the generators higher in operating cost and an amount of power generated by the generator higher in operating cost, or at least one power higher in unit price and the amount in which the power is purchased, a step of obtaining of the equation for predicting a cost for demand control from actual-record data on amounts of power demand control and control costs, and obtaining by simulation a cost required for demand control of the amount of power generated by the detected generator higher in operating cost or the mount in which the power higher in unit price is purchased, and a step of displaying the temporary generator operation plan draft, the temporary power purchase plan draft, the generator higher in operating cost or the power higher in unit price, and the cost required for demand control of the amount of power generated by the generator or the amount in which the power higher in unit price is purchased.

According to this method, a temporary power purchase plan draft, a temporary power purchase plan draft, generators higher in operating cost or powers higher in unit price, and the cost required for demand control of the amount of power generated by the generators or the amount in which the powers higher in unit price are purchased can be presented, and an electric power supplier can make an actual power purchase plan and an actual power purchase plan by considering these contents presented.

Also, the method comprises a step of extracting and setting a future power demand related to a supply plan period from power demand predicted value data, a step of obtaining the equation for predicting a cost for demand control from actual-record data on amounts of power demand control and control costs, a step of making a power purchase plan draft and a demand control draft by using data on purchase of power, and a power demand prediction and the equation for predicting a cost for demand control, obtained in the steps, and a step of displaying the power purchase plan draft and the demand control draft obtained.

According to this method, a power purchase plan draft made by considering power demand control can be presented, and an electric power supplier can make an actual power purchase plan by considering suitable amounts of power demand control and control costs, presented in the demand control draft.

Also, the method comprises a step of extracting and setting a future power demand related to a supply plan period from power demand predicted value data, a step of making a temporary power purchase plan draft from a power demand prediction obtained in the step and data on purchase of power, and detecting at least one power higher in unit price and the amount in which the power is purchased, and a step of obtaining the equation for predicting a cost for demand control from actual-record data on amounts of power demand control and control costs, and obtaining by simulation a cost required for demand control of the detected amount in which the power higher in unit price is purchased, and a step of displaying the temporary power purchase plan draft, the power higher in unit price, and the cost required for demand control of the amount in which the power higher in unit price is purchased.

According to this method, a power purchase plan draft, powers higher in unit price and the amount in which the powers are purchased can be presented, and an electric power supplier can make an actual power purchase plan by considering these contents presented.

### BRIEF DESCRIPTION OF DRAWINGS

FIG. 1 is a diagram for explaining a generator operation plan making support method according to Embodiment 1 of the present invention;

FIG. 2 is a diagram for explaining the generator operation plan making support method according to Embodiment 1 of the present invention;

FIG. 3 is a diagram for explaining a generator operation plan making support method according to Embodiment 2 of the present invention;

FIG. 4 is a diagram for explaining the generator operation plan making support method according to Embodiment 2 of the present invention;

FIG. 5 is a diagram for explaining a generator operation plan making support method according to Embodiment 3 of the present invention;

FIG. 6 is a diagram for explaining the generator operation plan making support method according to Embodiment 3 of the present invention;

FIG. 7 is a diagram for explaining a generator operation plan making support method according to Embodiment 4 of the present invention;

FIG. 8 is a diagram for explaining the generator operation plan making support method according to Embodiment 4 of the present invention;

FIG. 9 is a diagram for explaining a generator operation plan making support method according to Embodiment 5 of the present invention;

FIG. 10 is a diagram for explaining the generator operation plan making support method according to Embodiment 5 of the present invention;

FIG. 11 is a diagram for explaining a generator operation plan making support method according to Embodiment 6 of the present invention; and

FIG. 12 is a diagram for explaining the generator operation plan making support method according to Embodiment 6 of the present invention.

### BEST MODE FOR CARRYING OUT THE INVENTION

Embodiment 1

A power supply plan making support method according to Embodiment 1 of the present invention will be described by way of example with respect to a case where an enterprise organized as an electric power supplier such as an electric power company having a plurality of power generation facilities makes a generator operation plan by considering demand control. When the enterprise carries out demand control, it offers a discount or reward to customers (including electric power brokers as well as customers actually consuming electric power) as an incentive for control, which is a control cost imposed on the enterprise.

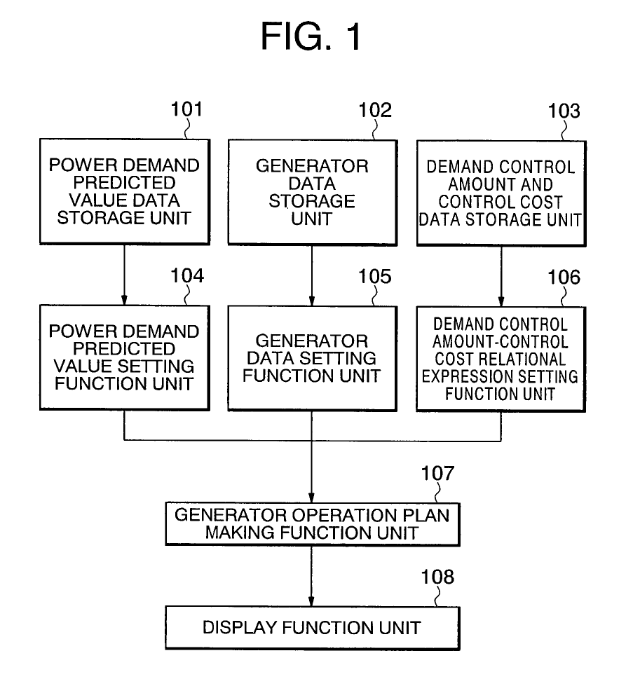

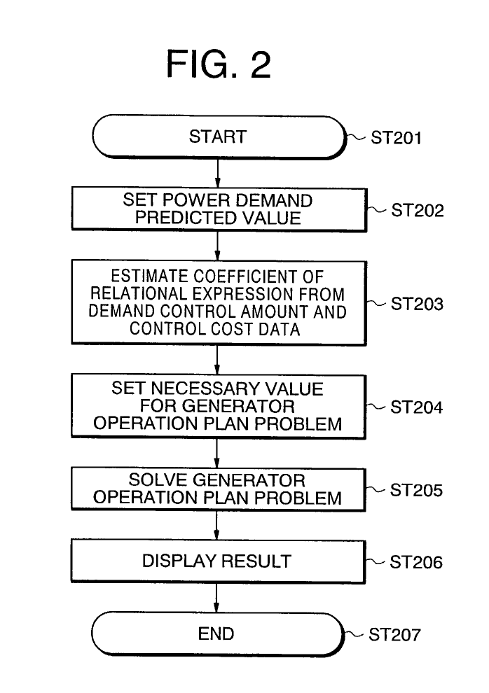

FIGS. 1 and 2 are diagrams for explaining the power supply plan making support method according to Embodiment 1 of the present invention. More specifically, FIG. 1 is a diagram of the configuration of a system for carrying out the power supply plan making support method, and FIG. 2 is a flowchart.

Referring to FIG. 1, indicated by 101, 102, and 103 are a power demand predicted value data storage unit which stores power demand predicted value data in future time sections, a generator data storage unit which stores generator data from which conditions are set as constraints on generator operation planning, and a power demand control amount and control cost storage unit which stores data on an actual record of amounts of power demand control and control costs for them. More specifically, the power demand predicted value data storage unit 101 contains, for example, items of data such as dates and predicted demands in future, and if a predicted demand during one hour from 13:00 to 14:00 on September 1 is 30 million kWh, data written as (9, 1, 13, 30,000,000) is stored. For example, such power demand predicted value data with respect to each hour in a day is obtained on the day before by a well-known method, e.g., a method based on regression analysis using weather factors as explanatory variables, a method using a pattern recognition technique such as an Al (artificial intelligence) technique using an expert system or fuzzy a hierarchical neural network method, or the like. In the generator data storage unit 102, items of data such as a startup cost, an incremental fuel cost, reserve power, output upper/lower limit values, a shortest stoppage time period, a shortest operation time period, etc., of each of generators are stored. Items of data stored in the power demand control amount and control cost data storage unit 103 are, for example, customer identification numbers (identification numbers 1, 2 . . . may be individually assigned to customers, customers may be grouped, for example, with respect to areas A, B . . . , and all customers may be collectively treated as one customer), times, amounts of demand control (kWh), and control costs (yen). For example, if the amount of demand control at a customer 1 during one hour from 13:00 to 14:00 is 600,000 kWh, and if an electricity bill discount per kWh from the electric power supplier with respect to the amount of demand control is 3.0 yen/kWh, the control cost is 1,800,000 yen and (1, 13, 600,000, 1, 800,000) is written as actual-record data. Such record data is measured at certain times, for example, with a load measuring device in a building management system on the customer (client) side and is collected via a network such as the Internet to a power supply plan making support system installed on the power supplier side to be accumulated and saved as time-series data.

A power demand predicted value setting function unit, a generator data setting function unit, and a power demand control amount-control cost relational expression setting function unit are respectively indicated by 104, 105, and 106. The power demand control amount-control cost relational expression setting function unit 106 sets a relational expression of an amount of power demand control and a control cost for it. That is, this function unit obtains an expression for predicting a cost for demand control. The groups of data in the data storage units 101, 102, and 103 are respectively set as constants or constraints relating to generator operation plan problems by the setting function units 104, 105, and 106. More specifically, the power demand predicted value setting function unit 104 extracts, for example, a predicted demand in each of time zones (hours) corresponding to the hours from 0 to 23 in the next day relating to a supply plan period from future demand prediction data in the power demand predicted value data storage unit 101, and sets the extracted demand as data input to a generator operation plan making function unit 107. The generator data setting function unit 105 extracts data on generators which are operable, for example, in the next day from the generator data storage unit 102, and sets values such as startup costs, incremental fuel costs, reserve power constraint, tide constraints, output upper/lower limit constraints, shortest stoppage time constraints, shortest operation time periods constraints, etc., which are necessary for solving a generator plan problem, as described below in detail. The power demand control amount-control cost relational expression setting function unit 106 organizes time-series data accumulated and saved in the record data storage unit 103 as data on amounts of power demand control and relating costs into a model by a quadratic equation by regarding the data as fuel cost characteristics with respect to outputs from virtual generators corresponding to the amounts of demand control, as described below in detail.

The generator operation plan making function unit 107 solves the generator operation plan problem as an optimization problem. This problem can be solved in a well-known manner, for example, as described in a publication (“Denryoku Keito Kogaku (electric power system engineering)” in the college lecture series from CORONA PUBLISHING CO., LTD.), a publication “Denryoku Shisutemu Kogaku (electric power system engineering)” in the semester college lecture from MARUZEN CO., LTD., etc. Therefore the solution will not be explained in detail.

The setting function units 104, 105, 106 and the generator operation plan making function unit 107 are realized, for example, by software programs loaded in a computer.

A display function unit for displaying computation results is indicated by 108. For example, the display function unit 108 is realized by a display device such as a CRT (Cathode Ray Tube) monitor or a liquid crystal.

The power supply plan making support method according to Embodiment 1 will next be described in more detail with reference to FIG. 2. A case where a generator operation plan in time sections at one-hour intervals in a day is made on the day before will be described by way of example.

The procedure is started in step ST201. In step ST202, a predicted demand in each of time zones (hours) corresponding to the hours from 0 to 23 in the next day relating to a supply plan period is extracted from future demand prediction data in the power demand predicted value data storage unit 101, and is set as data input to the generator operation plan making function unit 107.

In step ST203, the relationship between an amount of demand control and a control cost is estimated as described below by the power demand control amount-control cost relational expression setting function unit 106 using actual-record data on amounts of demand control and control costs stored in the power demand control amount and control cost data storage unit 103 when demand control was carried out.

If the amount of demand control is D and the control cost is W, the relationship therebetween is expressed by the following quadratic equation:

W=âD²+\hat{b}D+ĉ

Coefficients â, \hat{b}, and \hat{c} in this expression are estimated from the actual-record data on amounts of demand control and control costs. For estimation, a least square method, for example, can be used. Also, a method can be effectively used in which actual-record data is sorted with respect to the seasons, atmospheric temperature, days of the week, etc., and sorted actual-record data corresponding to the conditions on the demand prediction day is used.

In step ST204, values necessary for solving a generator plan problem shown below are set by the generator data setting function unit 105.

In step ST205, the following minimization problem is solved by the generator operation plan making function unit 107.

F=ΣΣfᵢ(gᵢ(t))→min

where F is an evaluation function, fi(gi) is the cost (fuel cost and startup cost) when generator i generates an amount of electricity g, and gi(t) is the output from generator i at time t.

Constraints to be considered include the output upper/lower limits, the shortest operation time, the shortest stoppage time, reserve power, and tide constraint. If a power demand predicted value at time t is G(t), one of demand and supply balance constraint expressions is given as shown by the following equation:

$${\sum }_{i = 1}^{n} {g}_{i} ( t ) = G ( t )$$

The relational expression of W and D obtained in step ST203 is regarded as the cost of a virtual generator d for demand control and is substituted in the evaluation function F and the constraint expression. That is, a virtual generator expressing the amount of demand control is set and the cost W when the amount of electricity D generated thereby is assumed to be expressed by a quadratic equation, and the cost and the amount of power generation of the virtual generator d are given by the following equation:

f(g_{d})=âg_{d}²(t)+\hat{b}g_{d}(t)+ĉ

The evaluation function F can be solved as a generator operation plan problem, for example, by dynamic programming and a constrained continuous-system optimization method.

In step ST206, a generator operation plan obtained in step ST205 is presented by the display function unit 108. In the generator operation plan draft displayed on the display function unit 108, a planned value of the amount of power generation assigned to the virtual generator corresponds to the amount of demand control, and the cost thereof corresponds to the control cost. For example, if it is predicted by demand prediction that a power peak will occur, a need may arise to operate one of the generators at a high operating cost at the time of occurrence of a peak. In such a case, if the cost of a virtual generator is lower than that of power generation by the generator with the high operating cost, a planned value for the amount of power generation is assigned as the amount of power generation from the virtual generator instead of operating the generator with the high operating cost. Also, a power demand exceeding the maximum possible total amount of power generation that the operating company has may be predicted. In such a case, a planned value for excess power is assigned as the amount of power generation from the virtual generator.

In step ST207, the procedural sequence ends.

Note that, the procedure shown in the flowchart of FIG. 2 is not exclusively used. For example, any one of steps ST202, ST203, and ST204 may precede the others.

Thus, a predicted cost for demand control is expressed by an equation to enable a generator operation plan draft to be made by techniques similar to those in the prior art and by considering demand control. Consequently, a suitable schedule (time) of carrying out demand control, amounts of demand control and control costs necessary for it can be presented to support an electric power supplier in making a generator operation plan by considering power demand control.

If an electric power supplier uses this method to cut a power peak, it can grasp amounts of demand control and costs necessary for control and carry out bargaining and making a contract for effective demand control. It can also compute amounts of demand control and control costs even in the case of lack of supply of power and carry out bargaining and making a contract for effective demand control.

A method will next be described which enables an enterprise (electric power supplier) having a plurality of power generation facilities to actually make a generator operation plan by considering power demand control on the basis of a generator operation plan draft presented by the display function unit 106.

The enterprise decides in advance to carry out demand control according to amounts of demand control, control costs and a demand control schedule (operating period of virtual generator) presented, and carries out bargaining with customers by presenting to the customers amounts of demand control and incentives for control, or carries out bargaining and making a contract therewith by preparing and presenting a toll menu for a certain period in which demand control is reflected. In this case, the control costs presented by the display function unit 106 are factored in the total amount of incentives.

Note that, if the electric power supplier can purchase electric power from some other supplier or power market, it may purchase an amount of electric power corresponding to an amount of demand control from another supplier or from a power market. At this time, since the electric power supplier is grasping the amount of demand control and the cost necessary for control, it may perform decision-making by comparing the cost necessary for control with the cost for purchase from another supplier or the power market to purchase electric power from the another supplier or the power market if the purchase cost is lower, or to carry out demand control if the control cost is lower.

Thus, cost comparison can be made comparatively decisively and a choice to purchase electric power from some other supplier can be evaluated, so that the electric power supplier can perform decision-making with accuracy.

Embodiment 2

Hereinafter, a power supply plan making support method according to Embodiment 2 of the present invention will be described below by way of example, as in Embodiment 1, with respect to a case where an enterprise organized as an electric power supplier such as an electric power company having a plurality of power generation facilities makes a generator operation plan by considering demand control.

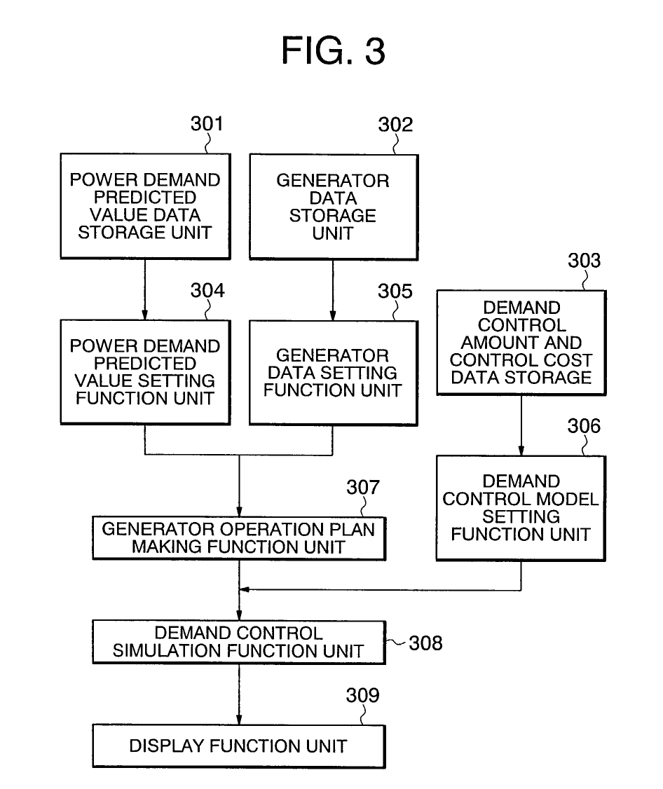

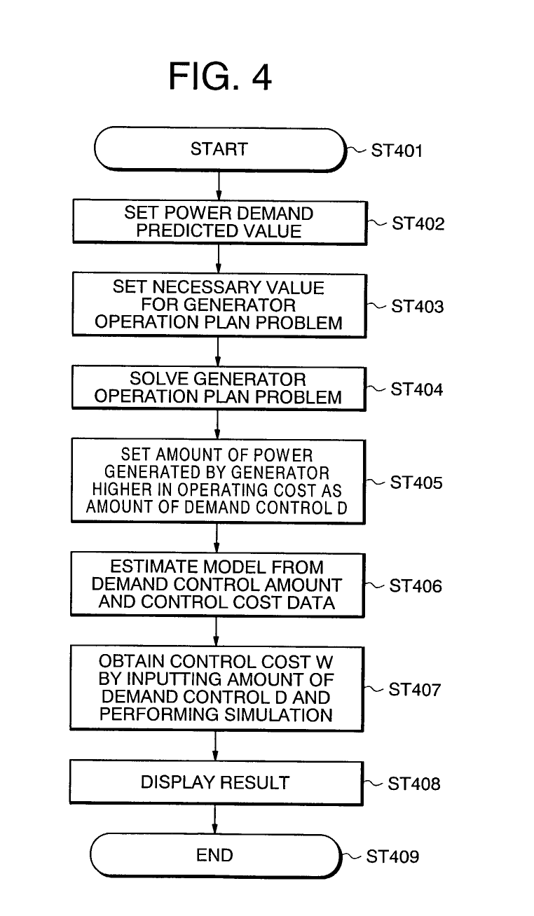

FIGS. 3 and 4 are diagrams for explaining the power supply plan making support method according to Embodiment 2 of the present invention. More specifically, FIG. 3 is a diagram of the configuration of a system for carrying out a generator operation plan making support method, and FIG. 4 is a flowchart.

Referring to FIG. 3, indicated by 301, 302, and 303 are a power demand predicted value data storage unit which stores power demand predicted value data in future time sections, a generator data storage unit which stores generator data from which conditions are set as constraints on generator operation planning, and a demand control amount and control cost data storage unit which stores data on an actual record of amounts of power demand control and control costs for them, in which the same data as that in the storage units 101, 102, and 103 described in the description of Embodiment 1 is stored, respectively.

A power demand predicted value setting function unit, a generator data setting function unit, and a demand control model setting function unit, i.e., a function unit for obtaining an expression for predicting a cost for demand control, are respectively indicated by 304, 305, and 306. Data is set in the data storage units 301 and 302 as constants and constraints relating to a generator operation plan problem by the setting function units 304 and 305, respectively, as in Embodiment 1. The demand control model setting function unit 306 forms a model of an actual record of demand control of each of customers, each of plural customer groups, or all the customers by using data from the demand control amount and control cost data storage unit 303.

A generator operation plan making function unit indicated by 307 solves the generator operation plan problem as an optimization problem. A demand control simulation function unit indicated by 308 performs a simulation relating to amounts of demand control and control costs by using the demand control result model with respect to each customer set by the demand control model setting function unit 306.

Note that, the setting function units 304, 305, and 306, the generator operation plan making function unit 307, and the demand control simulation function unit 308 are realized, for example, by software programs loaded in a computer.

A display function unit for displaying computation results is indicated by 309. For example, the display function unit 309 is realized by a display device such as a CRT (Cathode Ray Tube) monitor or a liquid crystal display.

Next, a power purchase plan making support method according to Embodiment 2 will be described in more detail with reference to the flowchart shown in FIG. 4. A case where a generator operation plan in time sections at one-hour intervals in a day is made on the day before will be described by way of example.

The procedure is started in step ST401. In step ST402, a predicted demand in each of time zones (hours) corresponding to the hours from 0 to 23 in the next day relating to a supply plan period is extracted from future demand prediction data in the power demand predicted value data storage unit 301, and is set as data input to the generator operation plan making function unit 307.

In step ST403, values necessary for solving a generator plan problem are set by the generator data setting function unit 305.

Subsequently, in step ST404, a generator operation plan ordinarily carried out, e.g., one without a virtual generator in Embodiment 1 is carried out by the generator operation plan making function unit 307 to obtain a temporary generator operation plan draft.

In step ST405, from generators to be operated in the temporarily generator operation plan draft obtained in step ST404, one highest in operating cost or two or more of them higher in operating cost are extracted as generators set as objects of demand control, and the amount of power generated from the extracted demand control object generators is set as an amount of demand control D (generators higher in operating cost and the amount of power generated from the generators are detected).

Also, in step ST406, a model of an actual record of demand control of each of customers, each of plural customer groups, or all the customers is formed by the demand control model setting function unit 306 using data from the demand control amount and control cost data storage unit 303 (a customer model representing the relationship between amounts of demand control and control costs is estimated). For example, an estimation method may be used in which the relationship between an amount of demand control d of customer i and a control cost w is described by a high-order polynomial.

wᵢ=âₒ+â₁dᵢ+â₂dᵢ²+. . . +âₖdᵢ^{k}

Also, the relationship may be approximated by learning of a neural network, for example.

In step ST407, the amount of control D (including time) obtained in step ST405 is input to a simulator for demand control simulation constituted by the customer model by the demand control simulation function unit 308, and simulation is repeated while correcting the control cost W to obtain the minimum of W. If the simulator is formed by considering simulation of bargaining between the demand control executor and the customers and by analyzing the influence of external factors (atmospheric temperature, days of the week, the seasons, events, etc.), simulation can be performed with accuracy.

In step ST408, the temporary generator operation plan draft obtained in step ST404, the generators and the amount of power detected in step ST405, i.e., the generators higher in operating cost and the amount of power generated therefrom, and the control cost obtained in step ST407 are displayed on the display function unit 309.

In step ST409, the procedural sequence ends.

The procedure shown in the flowchart of FIG. 4 is not exclusively used. For example, one of steps ST402 and ST403 may precede the other.

Thus, the function of simulating demand control is provided to enable the presentation of the control cost with respect to generators higher in operating cost to be extracted from the results obtained from the conventional generator operation plan. Therefore, the electric power supplier can know a schedule for carrying out suitable demand control, the amount of demand control, and the control cost necessary for it. Consequently, the electric power supplier can be supported in making a generator operation plan by considering power demand control.

Note that, a method which enables the electric power supplier to actually make a generator operation plan by considering demand control on the basis of the temporary generator operation plan draft, generators higher in operating cost and the amount of power generated therefrom, and the control cost required for demand control of the amount of power generated from the generators, displayed on the display function unit 309, is the same as that described Embodiment 1.

Here, if the electric power supplier can purchase electric power from some other supplier or power market, it may purchase an amount of electric power corresponding to an amount of demand control from another supplier or from a power market, as in the case of Embodiment 1. Since the electric power supplier is grasping the amount of demand control and the cost necessary for control, it can make decisive cost comparison between the cost necessary for control and the cost for purchase from another supplier of the power market and evaluate a choice to purchase electric power from some other supplier or power market. Thus, the power supplier can perform decision-making with accuracy.

Embodiment 3

While the description of Embodiment 1 is made by assuming that the electric power supplier itself makes cost comparison in the case of purchasing an amount of power corresponding to an amount of demand control from some other supplier, this embodiment will be described with respect to a case of presentation of a generator operation plan draft made by considering both demand control and purchase of electric power, by referring mainly to points of difference from Embodiment 1.

With respect to a case where an electric power supplier purchases electric power from some other supplier, a method of purchasing electric power at a contract price according to a relative contract with an individual power generation company or the like and a method of purchasing it by bargaining at a market price in an power market (pool type) are ordinarily taken into consideration. This embodiment will be described with respect to purchase by bargaining at a market price.

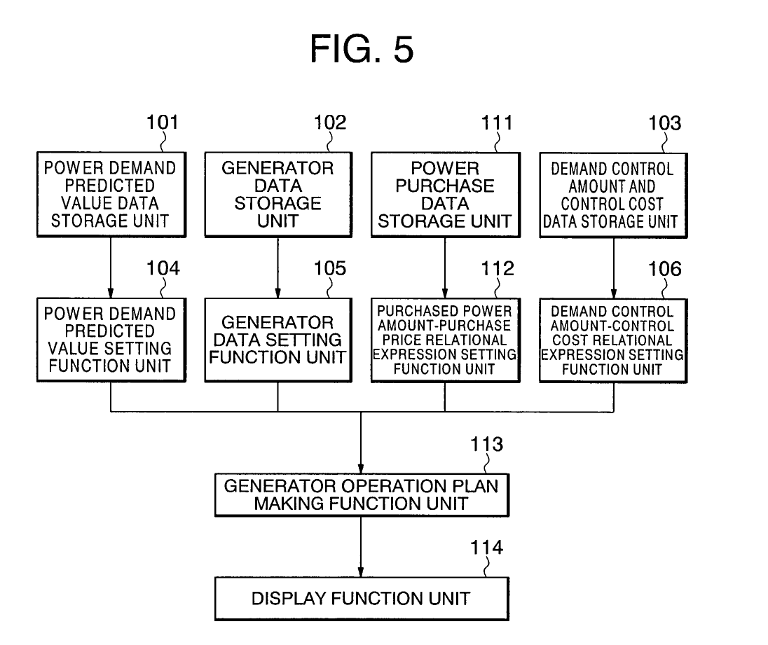

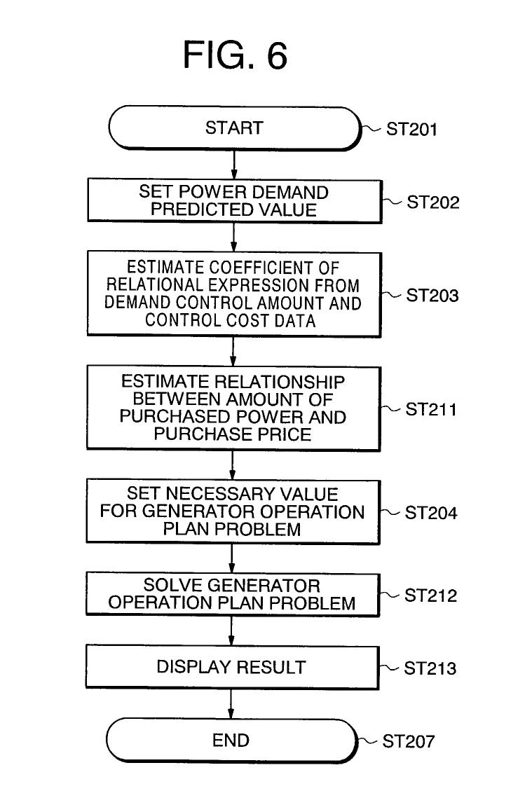

FIGS. 5 and 6 are diagrams for explaining the power supply plan making support method according to Embodiment 3 of the present invention. More specifically, FIG. 5 is a diagram of the configuration of a system for carrying out the power supply plan making support method, and FIG. 6 is a flowchart.

Referring to FIG. 5, a power purchase data storage unit indicated by 111 stores actual-record data on amounts of power purchased and purchase prices. If the data items are, for example, identification numbers of power markets, times, amounts of power purchased (kWh), and purchase prices (yen), and if the amount of power purchased from one power market 1 during one hour from 13:00 to 14:00 is, for example, 100,000 kWh and the purchase price is 400,000 yen, history data is written as (1, 13, 100,000, 400,000). Such history data is stored and saved at each time as time-series data in a power supply plan making support system provided in, for example, an office of an electric power supplier.

A purchased power amount-purchase price relational expression setting function unit indicated by 112 sets a relational expression of an amount of power purchased and a purchase price of it, that is, it obtains an expression for predicting a cost for purchase of power. A model of each power market is formed from past market data (amounts of power traded and prices of them). In this manner, markets can be treated by being incorporated in a generator operation plan, as is the virtual generator for demand control described in Embodiment 1.

A generator operation plan making function unit indicated by 113 solves the generator operation plan problem as an optimization problem.

Note that, the respective setting function units 104, 105, 106, and 112 and the generator operation plan making function unit 113 are realized, for example, by software programs loaded in a computer.

A display function unit for displaying computation results is indicated by 114. For example, the display function unit 114 is realized by a display device such as a CRT (Cathode Ray Tube) monitor or a liquid crystal display.

Next, the power supply plan making support method according to Embodiment 3 will be described in more detail with reference to the flowchart shown in FIG. 6, focusing on a point of difference from Embodiment 1. A case where a generator operation plan in time sections at one-hour intervals in a day is made on the day before will be described by way of example. Steps ST201 to ST203 are the same as those in Embodiment 1.

In step ST211, the relationship between an amount of purchased power and a purchase price is estimated by the purchased power amount-purchase price relational expression setting function unit 112 using actual-record data on amounts of purchased power and purchase prices (purchase costs) stored in the power purchase data storage unit 111, as shown below.

If the amount of purchased power is E and the purchase cost is V, the relationship therebteween is expressed by the following quadratic equation:

V=\hat{x}E²+ŷE+\hat{z}

Coefficients \hat{x}, ŷ, and \hat{z} in this expression are estimated from the actual-record data on amounts of purchased power and purchase costs. For estimation, a least square method, for example, can be used. In general, in a power market on one day, the price per hour on the next day is presented, and the power price depends on the time zone in which power is purchased. Therefore, preferably, one day is divided into a plurality of time zones and a relational expression in each time zone is estimated from the actual-record data on the amount of purchased power and the purchase price in each time zone. That is, in the case of division into M time zones, each relational expression is as shown below:

V=\hat{x}ₗE²+ŷₗE+\hat{z}ₗ(l=1, . . . , M)

Also, a method can be effectively used in which the actual-record data is sorted with respect to the seasons, temperatures, days of the week, etc., and the sorted actual-record data corresponding to the conditions on the demand prediction day is used.

Step ST204 is the same as that in Embodiment 1.

In step ST212, a minimization problem shown below is solved by the generator operation plan making function unit 113.

$$F = {\sum }_{ t = 0}^{23} {\sum }_{i = 1}^{n} {f}_{i} ( {g}_{i} ( t ) ) -> min$$

In Embodiment 1, a virtual generator representing an amount of demand control is set, cost W with respect to the amount of power generation D therefrom is assumed to be as expressed by a quadratic equation, and the cost and the amount of power generation of virtual generator d are given as shown by the following equation:

f(g_{d})=âg_{d}²(t)+\hat{b}g_{d}(t)+ĉ

In this embodiment, a virtual generator e representing an amount of purchased power is further set, a cost V when the amount of power generation therefrom is E is assumed to be as expressed by a quadratic equation, and the cost and the amount of power generation of virtual generator e are given as shown by the following equation:

f(gₑ)=\hat{x}gₑ²(t)+ŷgₑ(t)+\hat{z}

In the case of division into a plurality of time zones as described above, the cost and the amount of power generation of the first power generator e1 in the plurality of virtual generators are given as shown in an equation shown below. A constraint is imposed on these virtual generators such that each virtual generator is capable of outputting only in the divided time zone and necessarily has zero output in the other time zones.

$$f ( {g}_{el} ) = {\hat{x}}_{l} {g}_{el}^{2} ( t ) + {\hat{y}}_{l} {g}_{el} ( t ) + {\hat{z}}_{l}$$

The evaluation function F can be solved as a generator operation plan problem, for example, by dynamic programming and a constrained continuous-system optimization method.

In step ST213, a generator operation plan draft obtained in step ST212 is presented by the display function unit 114. In the operation plan draft displayed on the display function unit 114, a planned value of the amount of power generation assigned to the virtual generator d corresponds to the amount of demand control, and the cost thereof corresponds to the control cost. Also, a planned value of the amount of power generation assigned to the virtual generator e corresponds to the amount of purchased power, and the cost thereof corresponds to the purchase cost.

Here, the procedure shown in the flowchart of FIG. 6 is not exclusively used. For example, any one of steps ST202, ST203, ST204, and ST211 may precede the others.

According to this embodiment, as described above, a generator operation plan draft and a power purchase plan draft made by considering power demand control can be displayed and the electric power supplier can make an actual generator operation plan and an actual power purchase plan by considering suitable amounts of power demand control and the control costs for them, shown as the demand control draft, the amounts of purchased power, and the costs for them.

Note that, the description has been made with respect to a case where the entire amount of purchased power is purchased by bargaining at a market price. If a relative contract with an individual power generation company or the like is made to purchase a portion of the entire amount of power at a contract price, the corresponding amount may be previously subtracted from a power demand predicted value.

Embodiment 4

While the description of Embodiment 2 is made by assuming that the electric power supplier itself makes cost comparison in the case of purchasing an amount of power corresponding to an amount of demand control from some other supplier, this embodiment will be described with respect to a case of presentation of a generator operation plan draft made by considering both demand control and purchase of electric power, by referring mainly to points of difference from Embodiment 2.

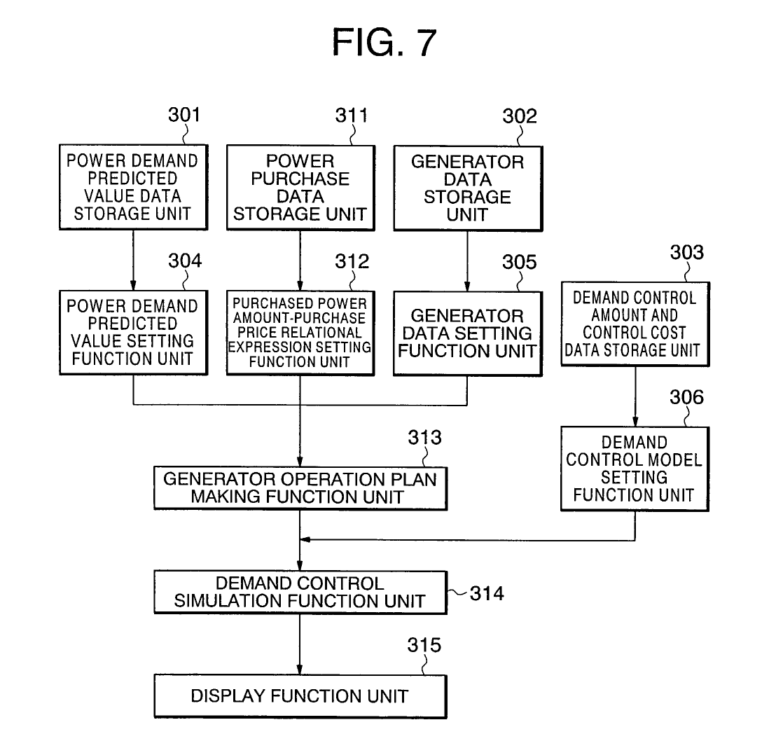

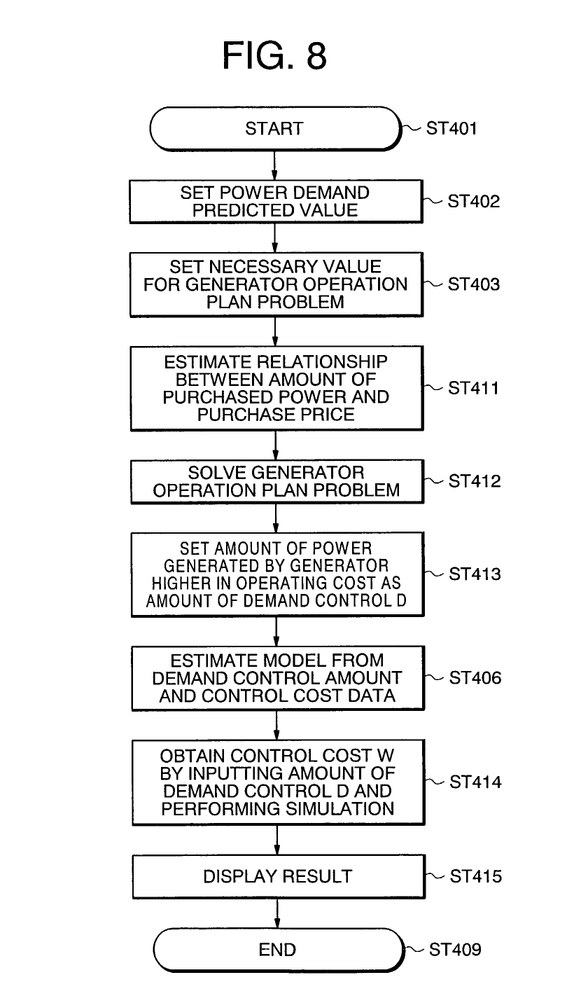

With respect to a case where an electric power broker purchases electric power from some other supplier, a method of purchasing electric power at a contract price according to a relative contract with an individual power generation company or the like and a method of purchasing it by bargaining at a market price in an power market (pool type) are ordinarily taken into consideration, as mentioned above in the description of Embodiment 3. This embodiment will be described with respect to a case where the entire amount of power to be purchased is purchased by bargaining at a market price. If a relative contract with an individual power generation company or the like is made to purchase a portion of the entire amount of power at a contract price, the corresponding amount may be previously subtracted from a power demand predicted value. FIGS. 7 and 8 are diagrams for explaining the power supply plan making support method according to Embodiment 4 of the present invention. More specifically, FIG. 7 is a diagram of the configuration of a system for carrying out the power supply plan making support method, and FIG. 8 is a flowchart.

Referring to FIG. 7, a power purchase data storage unit indicated by 311 stores actual-record data on amounts of power purchased and purchase prices. The same data as that in the power purchase data storage unit 111 described in the description of Embodiment 3 is stored in the power purchase data storage unit 311.

A purchased power amount-purchase price relational expression setting function unit indicated by 312 has the same function as the purchased power amount-purchase price relational expression setting function unit 112 described in the description of Embodiment 3.

A generator operation plan making function unit indicated by 313 solves the generator operation plan problem as an optimization problem.

A demand control simulation function unit indicated by 314 performs a simulation relating to amounts of demand control and control costs by using the demand control result model with respect to each customer set by the demand control model setting function unit 306.

Note that, the respective setting function units 304, 305, 306 and 312, the generator operation plan making function unit 313, and the demand control simulation function unit 314 are realized, for example, by software programs loaded in a computer.

A display function unit for displaying computation results is indicated by 315. For example, the display function unit 315 is realized by a display device such as a CRT (Cathode Ray Tube) monitor or a liquid crystal display.

Next, the power supply plan making support method according to Embodiment 4 will be described in more detail with reference to the flowchart shown in FIG. 8, focusing on a point of difference from Embodiment 2. A case where a generator operation plan in time sections at one-hour intervals in a day is made on the day before will be described by way of example.

Steps ST401 to ST403 are the same as those in Embodiment 2.

In step ST411, the relationship between an amount of purchased power and a purchase price is estimated by the purchased power amount-purchase price relational expression setting function unit 312 using actual-record data on amounts of purchased power and purchase prices (purchase costs) stored in the power purchase data storage unit 311, as in Embodiment 3.

Subsequently, in step ST412, a generator operation plan in a case where no virtual generator d exits in Embodiment 3 is carried out by the generator operation plan making function unit 313 to obtain a temporary generator operation plan draft. In the obtained temporary generator operation plan draft, a planned value of the amount of power generation assigned to the virtual generator e corresponds to the amount of purchased power, and the cost thereof corresponds to the purchase cost. Therefore, a temporary power purchase plan draft is also obtained.

In step ST413, the generator or power highest in operating cost or purchase price (unit price) or a plurality of generators or powers higher in operating cost or purchase price (unit price) in the temporarily operation plan draft obtained in step ST412 are extracted as generators or powers set as objects of demand control, and the amount of power generated from the extracted demand control object generators or the amount in which the extracted demand control object powers are purchased is set as an amount of demand control D (generators or powers higher in operating cost or unit price and the amount of power generated from the generators or the amount in which the powers are purchased are detected). More specifically, if the operating cost of generator i1 highest in operating cost is 7 yen, and if the unit price of power e1 highest in purchase price (unit price) is 6 yen, generator i1 is extracted as a generator or power of the highest operating cost or unit price. In a case where a plurality of generators or powers higher in operating cost or purchase price (unit price) are extracted, a consecutive sequence of a predetermined number of generators or powers from the highest rank or generators or powers of operating costs or purchase prices (unit costs) higher than a predetermined operating cost or purchase price (unit cost), for example, are extracted.

In step ST406, a model of an actual record of demand control of each of customers, each of plural customer groups, or all the customers is formed by the demand control model setting function unit 306 using data from the data storage unit 303 (a customer model representing the relationship between amounts of demand control and control costs is estimated), as in Embodiment 2.

In step ST414, the amount of control D (including time) obtained in step ST413 above is input to a simulator for demand control simulation constituted by the customer model, and simulation is repeated while correcting the control cost W to obtain the minimum of W. If the simulator is formed by considering simulation of bargaining between the demand control executor and the customers and by analyzing the influence of external factors (atmospheric temperature, days of the week, the seasons, events, etc.), simulation can be performed with accuracy.

In step ST415, the temporary generator operation plan draft (including the temporary power purchase plan draft) obtained in step ST412, the generators higher in operating cost and the amount of power generated therefrom or the power higher in unit price and the amount in which the power is purchased, detected in step ST413, and the control cost obtained in step ST414 are displayed.

In step ST409, the procedural sequence ends.

Note that, the procedure shown in the flowchart of FIG. 8 is not exclusively used. For example, any one of steps ST402, ST403, and ST411 may precede the others.

According to this embodiment, as described above, a temporary generator operation plan draft, a temporary power purchase plan draft, generators higher in operating cost and the amount of power generated by the generators, or powers higher in unit price and the amount in which the powers are purchased, and the cost required for demand control of the amount of power generated by the generators higher in operating cost or the amount in which the powers higher in unit price are purchased can be displayed, and the electric power supplier can make an actual power generator operation plan and an actual power purchase plan by considering these contents displayed.

Embodiment 5

The embodiments have been described with respect to the power supply plan making support method in the case where the electric power supplier has generators to meet at least part of a power demand by power generation. As Embodiment 5 and Embodiment 6 described below, a power supply plan making support method will be described with respect to a case where the power supplier is a so-called electric power broker who has no generator and who purchases power from other enterprises to meet the entire power demand, by referring mainly to points of difference from the above-described embodiments.

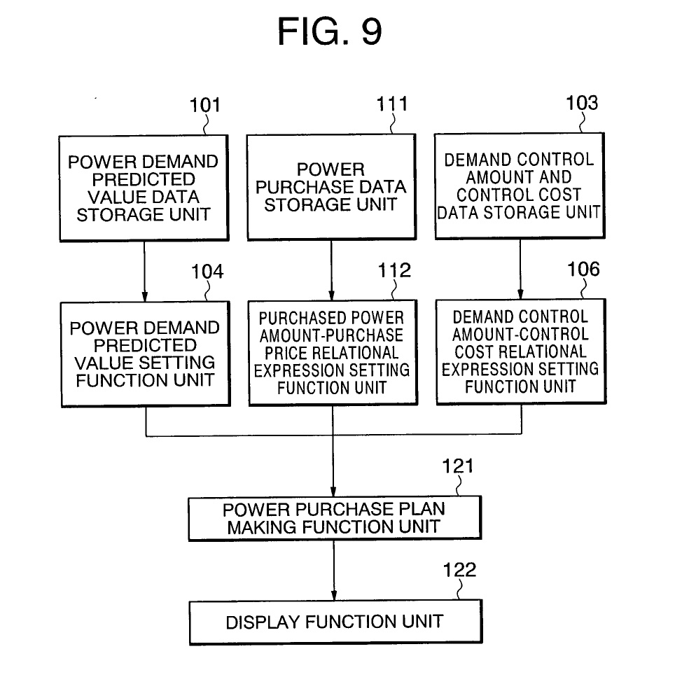

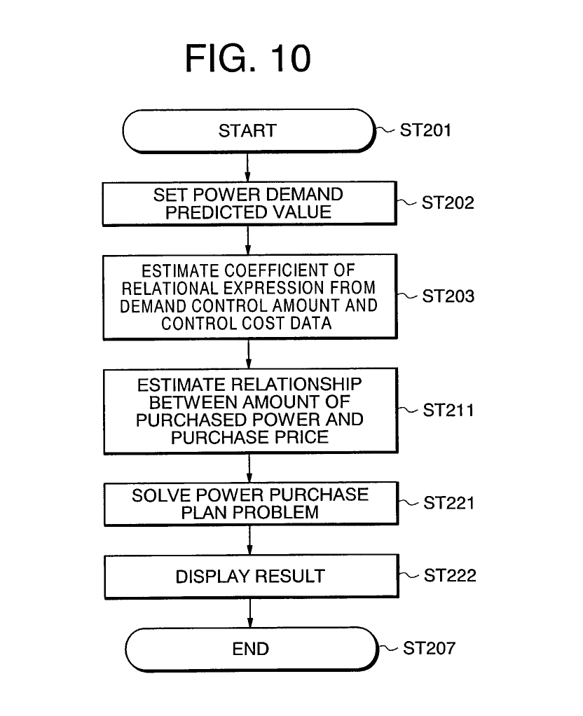

FIGS. 9 and 10 are diagrams for explaining the power supply plan making support method according to Embodiment 5 of the present invention. More specifically, FIG. 9 is a diagram of the configuration of a system for carrying out the power supply plan making support method, and FIG. 10 is a flowchart.

Referring to FIG. 9, a power purchase plan making function unit indicated by 121 solves a power purchase plan problem as an optimization problem. More specifically, if, in the above-described generator operation plan problem in each of the above-described embodiments, power purchase price data is substituted for the operating cost; and purchased power for the amount of power generation, the same optimization calculation can be performed. In particular, this corresponds to a case where there is no item relating to the generators in the optimization calculation in Embodiment 3. Note that, the setting function units 104, 106, and 112, and the power purchase plan making function unit 121 are realized, for example, by software programs loaded in a computer.

A display function unit for displaying computation results is indicated by 122. For example, the display function unit 122 is realized by a display device such as a CRT (Cathode Ray Tube) monitor or a liquid crystal display.

Next, the power supply plan making support method according to Embodiment 5 will be described in more detail with reference to the flowchart shown in FIG. 10, focusing on a point of difference from Embodiment 1 or Embodiment 3. A case where a generator operation plan in time sections at one-hour intervals in a day is made on the day before will be described by way of example.

Steps ST201 to ST203 and step ST211 are the same as those in Embodiment 3.

Subsequently, in step ST221, a power purchase plan problem is solved as an optimization problem. With respect to a plurality of virtual generators e representing amounts in which power is purchased and generators d representing amounts of demand control, cost equations:

f(gₑₗ)=\hat{x}ₗgₑₗ(t)+ŷₗgₑₗ(t)+\hat{z}ₗ(l=1, . . . , M)

f(g_{d})=â_{d}²(t)+\hat{b}g_{d}(t)+ĉ

constitute the following minimization problem to be solved:

$$F = {\sum }_{ t = 0}^{23} {\sum }_{i = 1}^{n} {f}_{i} ( {g}_{i} ( t ) ) -> min$$

where n=M+1. Power markets are essential sources from which electric power is purchased, depending on market management rules. Therefore no reserve power constraint, no shortest stoppage time period constraint and no shortest operation time period constraint exist on generators e. However, it is possible that tide constraints (depending on the idle transmission line capacity, etc., presupposed at the time of purchase) and output upper/lower limit constraints (limits to the minimum tradable power amount and the maximum purchasable amount) exit. In such a case, there is a need to solve a constrained minimization problem as well as the generator operation plan problem.

In step ST222, a power purchase plan draft obtained in step ST212 is presented by the display function unit 122.

The procedure shown in the flowchart of FIG. 10 is not exclusively used. For example, any one of steps ST202, ST203, and ST211 may precede the others.

According to this embodiment, as described above, a power purchase plan draft made by considering power demand control can be displayed and the electric power supplier can make an actual power purchase plan by considering suitable amounts of power demand control and the control costs for them, displayed in the demand control draft.

Embodiment 6

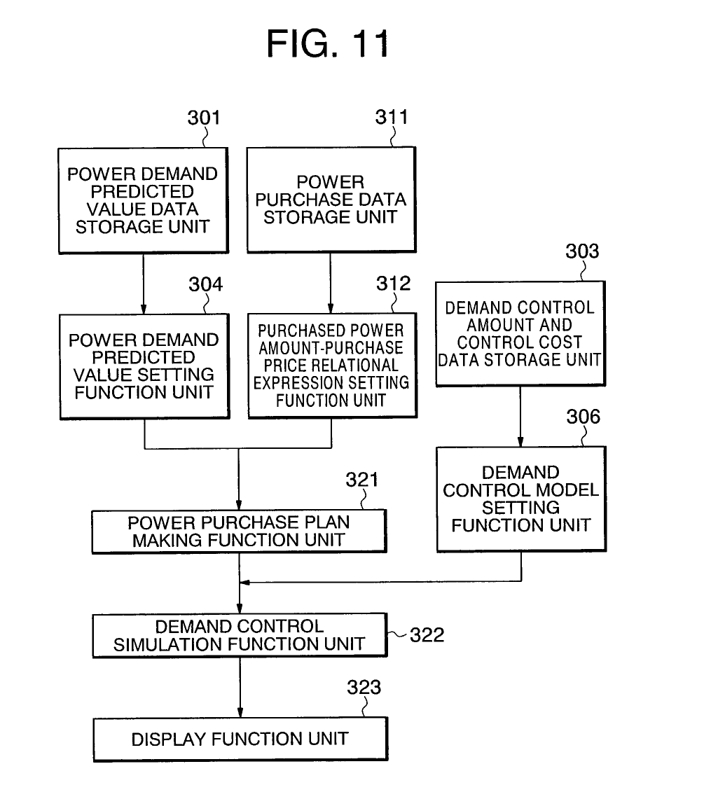

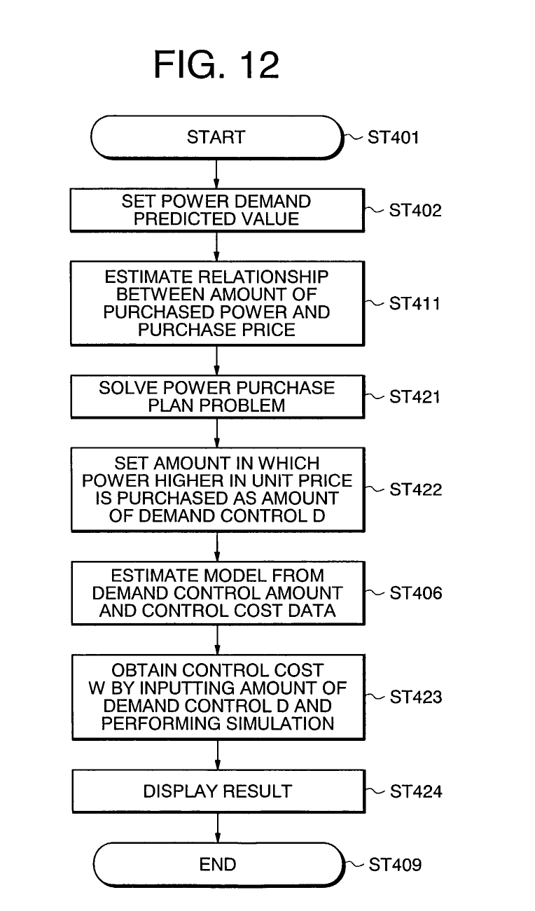

FIGS. 11 and 12 are diagrams for explaining the power supply plan making support method according to Embodiment 6 of the present invention. More specifically, FIG. 11 is a diagram of the configuration of a system for carrying out the power supply plan making support method, and FIG. 12 is a flowchart.

Referring to FIG. 11, a power purchase plan making function unit indicated by 321 solves a power purchase plan problem as an optimization problem.

A demand control simulation function unit indicated by 322 performs a simulation relating to amounts of demand control and control costs by using the demand control result model with respect to each customer set by the demand control model setting function unit 306.

Note that, the setting function units 304, 306, and 312, the power purchase plan making function unit 321, and the demand control simulation function unit 322 are realized, for example, by software programs loaded in a computer.

A display function unit for displaying computation results is indicated by 323. For example, the display function unit 323 is realized by a display device such as a CRT (Cathode Ray Tube) monitor or a liquid crystal display.

Next, the power supply plan making support method according to Embodiment 6 will be described in more detail with reference to the flowchart shown in FIG. 12, focusing on a point of difference from Embodiment 2 or Embodiment 4. A case where a generator operation plan in time sections at one-hour intervals in a day is made on the day before will be described by way of example.

Steps ST401, ST402 and ST411 are the same as those in Embodiment 4.

Subsequently, in step ST421, a power operation plan in a case where demand control is not performed in Embodiment 5 is carried out by the power purchase plan making function unit 321 to obtain a temporary power purchase plan draft.

In step ST422, the power highest in purchase price (unit price) or a plurality of powers higher in purchase price (unit price) in the temporarily power purchase plan draft obtained in step ST421 are extracted as powers set as objects of demand control, and the amount in which the extracted demand control object powers are purchased is set as an amount of demand control D (powers higher in unit price and the amount in which the powers are purchased are detected).

In step ST406, a model of an actual record of demand control of each of customers, each of plural customer groups, or all the customers is formed by the demand control model setting function unit 306 using data from the demand control amount and control cost data storage unit 303 (a customer model representing the relationship between amounts of demand control and control costs is estimated), as in each of Embodiments 2 and 4.

In step ST423, the amount of control D (including time) obtained in step ST422 above is input to a simulator for demand control simulation constituted by the customer model, and simulation is repeated while correcting the control cost W to obtain the minimum of W. If the simulator is formed by considering simulation of bargaining between the demand control executor and the customers and by analyzing the influence of external factors (atmospheric temperature, days of the week, the seasons, events, etc.), simulation can be performed with accuracy.

In step ST424, the temporary power purchase plan draft obtained in step ST421, the powers higher in unit price and the amount in which the powers are purchased, obtained in step ST422, and the control cost obtained in step ST423 are displayed.

Note that, the procedure shown in the flowchart of FIG. 12 is not exclusively used. For example, one of steps ST402 and ST411 may precede the other.

According to this embodiment, as described above, a temporary power purchase plan draft, powers higher in unit price, and the cost required for demand control of the amount in which the powers higher in unit price are purchased can be presented, and the electric power supplier can make an actual power purchase plan by considering these contents presented.

Note that, the embodiments have been described with respect to the case where the display function unit is realized by a display device. However, the arrangement is not limited to this. For example, the display function unit may be realized by a printing apparatus.

### INDUSTRIAL APPLICABILITY

The power supply plan making support method in accordance with the present invention can be used, for example, in a case where an electric power supplier, e.g., an enterprise having a plurality of power generation facilities, or an electric power broker makes a generator operation plan or a power purchase plan by considering power demand control.

1. A power supply plan making support method characterized in that an equation for predicting a cost for demand control is obtained from actual-record data on amounts of power demand control and control costs, and computation for presenting information for an electric power supply plan is performed by using said equation.

2. A power supply plan making support method according to claim 1, characterized by comprising a step of extracting and setting a future power demand related to a supply plan period from power demand predicted value data, a step of obtaining the equation for predicting a cost for demand control from actual-record data on amounts of power demand control and control costs, a step of making a generator operation plan draft and a demand control draft by using data on generators and a power demand prediction and the equation for predicting a cost for demand control, obtained in said steps, and a step for displaying the generator operation plan draft and the demand control draft obtained.

3. A power supply plan making support method according to claim 1, characterized by comprising a step of extracting and setting a future power demand related to a supply plan period from power demand predicted value data, a step of making a temporary generator operation plan draft from a power demand prediction obtained in said step and data on generators, and detecting at least one of the generators higher in operating cost and an amount of power generated by the generator higher in operating cost, a step of obtaining of the equation for predicting a cost for demand control from actual-record data on amounts of power demand control and control costs, and obtaining by simulation a cost required for demand control of the amount of power generated by the detected generator higher in operating cost, and a step of displaying the temporary generator operation plan draft, the generator higher in operating cost, and the cost required for demand control of the amount of power generated by the generator.

4. A power supply plan making support method according to claim 1, characterized by comprising a step of extracting and setting a future power demand related to a supply plan period from power demand predicted value data, a step of obtaining the equation for predicting a cost for demand control from actual-record data on amounts of power demand control and control costs, a step of making a generator operation plan draft, a power purchase plan draft and a demand control draft by using data on generators, data on purchase of power, and a power demand prediction and the equation for predicting a cost for demand control, obtained in said steps, and a step for displaying the generator operation plan draft, the power purchase plan draft and the demand control draft obtained.

5. A power supply plan making support method according to claim 1, characterized by comprising a step of extracting and setting a future power demand related to a supply plan period from power demand predicted value data, a step of making a temporary generator operation plan draft and a temporary power purchase plan draft from a power demand prediction obtained in said step, data on generators and data on purchase of power, and detecting at least one of the generators higher in operating cost and an amount of power generated by the generator higher in operating cost, or at least one power higher in unit price and the amount in which the power is purchased, a step of obtaining of the equation for predicting a cost for demand control from actual-record data on amounts of power demand control and control costs, and obtaining by simulation a cost required for demand control of the amount of power generated by the detected generator higher in operating cost or the mount in which the power higher in unit price is purchased, and a step of displaying the temporary generator operation plan draft, the temporary power purchase plan draft, the generator higher in operating cost or the power higher in unit price, and the cost required for demand control of the amount of power generated by the generator or the amount in which the power higher in unit price is purchased.

6. A power supply plan making support method according to claim 1, characterized by comprising a step of extracting and setting a future power demand related to a supply plan period from power demand predicted value data, a step of obtaining the equation for predicting a cost for demand control from actual-record data on amounts of power demand control and control costs, a step of making a power purchase plan draft and a demand control draft by using data on purchase of power, and a power demand prediction and the equation for predicting a cost for demand control, obtained in said steps, and a step of displaying the power purchase plan draft and the demand control draft obtained.

7. A power supply plan making support method according to claim 1, characterized by comprising a step of extracting and setting a future power demand related to a supply plan period from power demand predicted value data, a step of making a temporary power purchase plan draft from a power demand prediction obtained in said step and data on purchase of power, and detecting at least one power higher in unit price and the amount in which the power is purchased, and a step of obtaining the equation for predicting a cost for demand control from actual-record data on amounts of power demand control and control costs, and obtaining by simulation a cost required for demand control of the detected amount in which the power higher in unit price is purchased, and a step of displaying the temporary power purchase plan draft, the power higher in unit price, and the cost required for demand control of the amount in which the power higher in unit price is purchased.
